(19) United States
(12) Patent Application Publication
(10) Pub. No.: US 2023/0311366 A1
(43) Pub. Date: Oct. 5, 2023

(54) UD TAPE WITH IMPROVED PROCESSING CHARACTERISTICS AND ROUGHENED SURFACE AND METHOD FOR PRODUCTION THEREOF

(71) Applicant: Toray Advanced Composites, Nijverdal (NL)

(72) Inventors: Hans LUINGE, Nijverdal (NL); Joris MARKENSTEIN, Nijverdal (NL)

(73) Assignee: Toray Advanced Composites, Nijverdal (NL)

(21) Appl. No.: 18/043,325

(22) PCT Filed: Aug. 25, 2021
(86) PCT No.: PCT/EP2021/073523

§ 371 Date: Feb. 27, 2023

(30) Foreign Application Priority Data
Aug. 28, 2020 (EP) 20193389.2

(51) Int. Cl. B29B 11/16; B29C 70/20; B29B 15/12

(52) U.S. Cl. CPC B29B 11/16; B29C 70/20; B29B 15/125; B29K 2101/12

(57) ABSTRACT

The present invention relates to a method for producing a unidirectional tape with a surface polymer layer, the method comprising the steps of a) providing an impregnation slurry comprising particles of a polymer, water, optionally a surfactant, optionally an organic carrying medium, optionally organic compounds and optionally surface active compounds, and providing a pressing tool having a surface profile structure, the surface profile structure having a surface roughness Ra of 1 to 20 μm, preferably of 2 to 10 μm, more preferably 3 to 7 μm, b) impregnating a unidirectional fiber layer comprising unidirectional fibers with the impregnation slurry to obtain an impregnated unidirectional fiber layer comprising the particles of the polymer, c) pressing at a surface of the impregnated unidirectional fiber layer with the surface profile structure to move at least some of the particles of the polymer within the impregnated unidirectional fiber layer onto the surface to form a surface polymer layer on the unidirectional fiber layer, and d) obtaining a unidirec

The present invention relates to a UD tape with improved processing characteristics and roughened surface and a method for production thereof.

Unidirectional tapes (“UD tapes”) are fiber-reinforced tapes of different widths and are known for many years. Unidirectional aligned reinforcing fibers are typically impregnated with thermoplastic polymers, whereby the reinforcing fibers are usually carbon fibers or glass fibers. UD tapes can be used to make structures having advantageous structural characteristics, such as high stiffness and high strengths as well as low weights, when compared to structures formed from other conventional materials. As a result, UD tapes are used in a variety of applications across a wide range of industries, including the automotive, aerospace and consumer electronics industries. Depending on its application, a UD tape may need to meet a number of criteria, including those relating to mechanical performance such as strength or stiffness, size, weight as well as good processability and formability into complex shapes.

Subsequent processing of UD tapes typically encompasses melting of the thermoplastic polymer present in UD tapes to build up a coherent stack or a laminate of multiple plies. These processes include tacking, tape placement, tape laying, consolidation and welding. Most processes thus require the melting and interdiffusion of the thermoplastic polymer present at the interface of adjacent UD tapes so as to form a fully consolidated laminate.

Improved processing capabilities are sought for in the art for UD tapes. Such improved processing capabilities means fast deposition, consolidation characteristics, thermoforming behaviour and lateral flow for complex shapes as well as a roughened surface for improved processing.

There is thus a need in the art to provide UD tapes having improved lateral flow and at the same time a roughened surface for improved processing.

There is also a need in the art to provide a method for producing UD tapes having improved lateral flow and at the same time a roughened surface for improved processing.

It is thus an object of the invention is to provide a UD tape having improved lateral flow and at the same time a roughened surface for improved processing.

It is also an object of the present invention is to provide a method for producing a UD tape having improved lateral flow and at the same time a roughened surface for improved processing.

It has been found that all the above objects can be solved by a method for producing a UD tape having a layer of polymer at the surface of the unidirectional fiber layer. In other words, a UD tape is produced by pressing a surface of a unidirectional fiber layer to form a roughened surface polymer layer on the unidirectional fiber layer, wherein the roughened surface polymer layer provides for improved lateral flow.

The present invention therefore provides a method for producing a unidirectional tape with a surface polymer layer, the method comprising the steps of
a) providing an impregnation slurry comprising particles of a polymer, water, optionally a surfactant, optionally an organic carrying medium, optionally organic compounds and optionally surface active compounds, and providing a pressing tool having a surface profile structure, the surface profile structure having a surface roughness Ra of 1 to 20 μm, preferably of 2 to 10 μm, more preferably 3 to 7 μm,
b) impregnating a unidirectional fiber layer comprising unidirectional fibers with the impregnation slurry to obtain an impregnated unidirectional fiber layer comprising the particles of the polymer,
c) pressing at a surface of the impregnated unidirectional fiber layer with the surface profile structure to move at least some of the particles of the polymer within the unidirectional fiber layer onto the surface to form a surface polymer layer on the unidirectional fiber layer,
d) obtaining a unidirectional tape with a surface polymer layer.

The present invention further provides a unidirectional tape with improved processing characteristics and roughened surface obtained by the method according to the invention.

The present invention further has several surprising advantages.

Due to formation of the surface polymer layer an increased polymer content is present at the surface of the UD tape which, in turn, improves the lateral flow and decreases friction between plies and between tooling and composite stacks. The improved lateral flow and the decreased friction increases the formability of the tape and allows for faster forming and/or forming of more complex shapes.

Tailoring the surface polymer layer by pressing with a surface profile structure further allows at the same time to provide a certain surface roughness to the UD tape, and maintaining a low void and homogenous UD tape material.

The method for producing a unidirectional tape (UD tape) according to the invention is described in more detail in the following.

The impregnation slurry used in the method of the invention comprises particles of a polymer, water, optionally a surfactant, optionally an organic carrying medium, optionally organic compounds and optionally surface active compounds.

Preferably, the water is deionized water.

Preferably the organic carrying medium comprises an alcohol. Preferably the organic compound comprises an antifoaming agent. Preferably the surface active compound comprises a surfactant.

Furthermore, a pressing tool is provided, the pressing tool having a surface profile structure. The surface profile structure has a surface roughness Ra of 1 to 20 μm, preferably of 2 to 10 μm, and more preferably of 3 to 7 μm. The pressing tool presses at least one surface of the unidirectional fiber layer, preferably the pressing tool presses two surfaces of the unidirectional fiber layer, that is a first surface and a second surface opposite the first surface of the unidirectional fiber layer.

In case the two surfaces of the unidirectional fiber layer are pressed by the pressing tool, the pressing tool comprises a first pressing tool and a second pressing tool. The first pressing tool presses the first surface of the unidirectional layer, whereas the second pressing tool presses the second surface opposite the first surface of the unidirectional fiber layer.

Preferably, the first pressing tool is identical to the second pressing tool.

In step b) the unidirectional fiber layer is impregnated with the impregnation slurry to obtain an impregnated unidirectional fiber layer comprising the particles of the polymer. The unidirectional fiber layer comprises unidirectional fibers. These unidirectional fibers are generally arranged to lie in a unidirectional orientation. In other words, the plurality of fibers generally lie parallel to each other. Preferably, at least 75% of the fibers of the unidirectional fiber layer lie in a unidirectional orientation, more preferably at least 80%, even more preferably at least 90%, and most preferably at least 95%. The unidirectional fibers comprise or consist of filaments. The number of filaments which form a fiber can vary. Typically, a unidirectional fiber may be formed from 12000 or 24000 filaments. The diameter of a filament is typically 5 to 7 μm.

The unidirectional fiber layer has two opposite surfaces, a first surface and a second surface.

The particles of polymer deposit or adhere between adjacent unidirectional fibers and/or adjacent filaments of unidirectional fibers and also deposit or adhere on a surface of the unidirectional fiber layer, preferably on the two surfaces of the unidirectional fiber layer, during impregnation step b). In other words, the particles of polymer can penetrate into the unidirectional fiber layer and adhere on a surface of the unidirectional fiber layer, preferably on the two surfaces of the unidirectional fiber layer.

The particles of polymer may have a particle size typically in the range of from 10 μm to 500 μm, or preferably 15 to 100 μm, or more preferably 20 to 25 μm. The particle size can be measured by laser diffraction analysis, for example using laser diffraction particle size analyser S3500, commercially available from Microtrac.

Preferably step b) takes place in an impregnation bath, i.e. a vessel containing the impregnation slurry. The unidirectional fiber layer is impregnated with the impregnation slurry preferably by moving the unidirectional fiber layer through the impregnation bath. Preferably, the impregnation slurry is agitated during step b).

The method of the invention further comprises step c) of pressing at a surface of the unidirectional fiber layer with the surface profile structure to move at least some of the particles of the polymer within the unidirectional fiber layer onto the surface to form a surface polymer layer on the unidirectional fiber layer. The surface profile structure of the pressing tool presses at the impregnated unidirectional fiber layer comprising the particles of the polymer. Pressing does not change the unidirectional orientation of the fibers in the impregnated unidirectional fiber layer, but forces at least some of the particles of the polymer located within the impregnated unidirectional fiber layer to move onto one, or preferably both, surface(s) of the impregnated unidirectional fiber layer. Hence, these particles of polymer being moved onto one or both surfaces of the impregnated unidirectional fiber layer form a surface polymer layer on a surface of the impregnated unidirectional fiber layer, preferably form surface polymer layers on opposite surfaces of the impregnated unidirectional fiber layer. Preferably, the surface polymer layer(s) comprise, preferably consist of, the polymer.

Preferably, step c) comprises pressing, preferably at the same time, at both surfaces of the impregnated unidirectional fiber layer with the surface profile structure to move at least some of the particles of the polymer within the impregnated unidirectional fiber layer onto both surfaces to form surface polymer layers on opposite surfaces of the impregnated unidirectional fiber layer.

Preferably, pressing step c) is performed while the impregnated unidirectional fiber layer is at a temperature T being in the range

(Tc−150° C.)≤T≤(Tc+150° C.)

wherein Tc is the crystallization temperature of the polymer. More preferably, the temperature is in the range (Tc−50° C.)≤T≤(Tc+50° C.), more preferably (Tc−25° C.)≤T≤(Tc+25° C.), and most preferably (Tc−10° C.)≤T≤(Tc+10° C.). The temperature T of the impregnated unidirectional fiber layer as well as the crystallization temperature Tc of the polymer are expressed in ° C.

After pressing, in step d) the unidirectional tape with a surface polymer layer is obtained.

Preferably, the thickness of the surface polymer layer is between 1 to 15 μm, more preferably between 2 and 10 μm, and most preferably between 4 and 6 μm.

Preferably, the polymer is a thermoplastic polymer.

Preferably, the thermoplastic polymer comprises, or consists of, polyaryletherketone (PAEK)-based polymeric material, polyphenylene sulphide (PPS), polyetherimide (PEI), polyethersulfone (PESU, PES) or polysulfone (PSU), more preferably thermoplastic polymer comprises, or consists of, polyaryletherketone (PAEK)-based polymeric material or polyphenylene sulphide (PPS).

Preferably, the polyaryletherketone (PAEK)-based polymeric material is selected from the group consisting of poly-ether-ketone (PEK), polyether-ether-ketone (PEEK), poly-ether-ether-ketone -ketone (PEEKK), poly-ether-ether-ketone-ketone (PEKK), poly-ether- ketone-ether-ketone-ketone (PEKEKK), poly-ether-ether-ketone-ether-ketone (PEEKEK), poly-ether-ether-ether-ketone (PEEEK), and poly-ether-diphenyl-ether-ketone (PEDEK), meta-polyether-ether-ketone (PEmEK), polyaryletherketone (PAEK)-based polymeric material with reactive (end) groups, copolymers thereof and blends thereof, more preferably the polyaryletherketone (PAEK)-based polymeric material is selected from the group consisting of poly-ether-diphenyl-ether-ketone (PEDEK), polyether-ether-ketone (PEEK) and copolymers thereof, and most preferably a copolymer of poly-ether-diphenyl-ether-ketone (PEDEK) and polyether-ether-ketone (PEEK).

Preferably, the unidirectional fibers are carbon fibers and/or glass fibers and/or quartz, more preferably are carbon fibers. Suitable carbon fibers are, for example, Torayca T700G and Torayca T800G, both commercially available from Toray. The unidirectional fibers are preferably continuous fibers, more preferably continuous carbon fibers.

Preferably, the pressing tool and/or the surface profile structure of the pressing tool are made of metal or a metal alloy, such as iron or steel.

Preferably, the pressing tool is a pressing roll. Preferably, the impregnated unidirectional fiber layer comprising the particles of polymer is pressed by passing, more preferably continuously passing, the unidirectional fiber layer through the pressing role and a flat supporting substrate.

In case two surfaces of the unidirectional fiber layer are pressed by the pressing tool, the pressing roll comprises a first pressing roll and a second pressing roll. Preferably, the impregnated unidirectional fiber layer comprising the particles of polymer is pressed by passing, more preferably continuously passing, through the first pressing roll and a second pressing roll. Preferably, the first pressing roll is identical to the second pressing roll. Preferably, the surface profile structure of the first pressing roll is identical to the surface profile structure of the second pressing roll.

The pressing tool has a surface profile structure. Surface profile structure means that the surface of the pressing tool, with which the impregnated unidirectional fiber layer is pressed, is not fully flat.

Preferably, the surface profile structure comprises protrusions for pressing the impregnated unidirectional fiber layer and recesses for receiving the polymer pressed out of the impregnated unidirectional fiber layer. The protrusions of the surface profile structure of the pressing tool press at the impregnated unidirectional fiber layer comprising the particles of the polymer. Pressing does not change the unidirectional orientation of the fibers in the impregnated unidirectional fiber layer, but forces the particles of the polymer located within the impregnated unidirectional fiber layer to move onto one, or referably both, surface(s) of the impregnated unidirectional fiber layer.

Hence, these particles moved onto one or both surfaces of the impregnated unidirectional fiber layer form a surface polymer layer on a surface of the impregnated unidirectional fiber layer.

Preferably, the protrusions and the recesses are arranged in a pattern, the pattern being preferably a regular or random pattern, more preferably a regular pattern. A regular pattern is, for instance, a plurality of rows of protrusions wherein the distance between adjacent protrusions are equal. A random pattern is, for instance, where the protrusions are randomly arranged, i.e. the distance between adjacent protrusions are not equal or at least not always equal.

The roughened surface profile structure of the pressing tool in step c) causes the formed surface polymer layer to have a surface roughness. Preferably, the surface polymer layer has a surface roughness Ra of 1 to 20 μm, preferably 2 to 10 μm, more preferably 3 to 7 μm, measured according to ISO 4287.

Preferably, obtaining step d) comprises drying the unidirectional fiber layer.

Preferably, the method further comprises the step of e) drying the unidirectional fiber layer between impregnating step b) and pressing step c).

Preferably, the method further comprises further the step of f) cooling the unidirectional fiber layer before or while performing pressing step c).

Preferably, the cooling of step f) is performed through the pressing tool, more preferably by the pressing roll.

Preferably, the method according to the invention further comprises step g) of electrostatically depositing secondary particles on the surface polymer layer, ore preferably electrostatically depositing secondary particles on both surface polymer layers. Thereby, an additional surface polymer layer comprising or consisting of secondary particles can be formed on one or both surface polymer layers of the unidirectional tape. In other words, a unidirectional tape with one or two additional surface polymer layers can be obtained. The one or two additional surface layer(s) are preferably the outermost layer(s) of the unidirectional tape. This allows for tailoring and fine tuning the properties of the surface of the UD tape, in particular for specific applications.

Preferably, electrostatic depositing is performed via electro spraying. Electro spraying is preferably done using one or more spraying guns.

Step g) is preferably conducted after step c) and before step d) or after step d), more preferably after step d). Preferably, the unidirectional tape with one or two additional surface polymer layers is dried or consolidated after step d).

The secondary particles comprise, preferably consist of, a second polymer. Preferably, the second polymer is a thermoplastic polymer. The thermoplastic polymer is the same as described herein above for the polymer used in step a). Preferably, the second polymer is a polymer of the same class or the same subclass as the polymer of step a) or the second polymer is a polymer of a class or a subclass other than the polymer of step a).

The secondary particles have a particle size of preferably 10 μm to 500 μm more preferably 15 μm to 250 μm, and most preferably 20 μm to 200 μm. The size of the secondary particles must be such that they can be electrostatically deposited, more preferably deposited by electro spraying. The particle size can be measured by laser diffraction analysis as described above.

The present invention is also concerned with a unidirectional tape obtained by the method according to the invention. All embodiments of the method of the invention as described above are also preferred embodiments of the unidirectional tape obtained by the method according to the invention.

The invention thus provides a unidirectional tape comprising a unidirectional fiber layer and a surface polymer layer, preferably two surface polymer layers, wherein the unidirectional fiber layer comprises unidirectional fibers and particles of a polymer and wherein the surface polymer layer comprises particles of the polymer, characterized by the surface polymer layer having a surface roughness Ra of 1 to 20 μm measured according to ISO 4287 and having a thickness of less than 15 μm, preferably less than 10 μm.

Preferably, the unidirectional tape further comprises a transition zone, wherein the transition zone is located between the unidirectional fiber layer and the surface polymer layer, wherein a thickness of the transition zone is between 2 to 15 μm. The transition zone is the zone where the transition from the surface polymer layer comprising the pure polymer to the unidirectional layer comprising both unidirectional fibers and polymer takes place.

The surface polymer layer has a thickness. This thickness may not be constant over the whole area of the surface polymer layer but may vary to some extent. Preferably, a thickness variation of the surface polymer layer is between 0 and 75% of an average surface polymer layer thickness, preferably less than 30%, preferably less than 10%.

The transition zone and the thickness variation was measured as follows. The obtained unidirectional tape was cut into several slices. Optical microscopy was used to analyse cross-sections of these pieces of the tape. The thickness of the surface polymer layer was measured at least two times on at least five different slices. The average surface polymer thickness is calculated as the arithmetic mean thereof. From the surface polymer layer thickness and the average surface polymer thickness the thickness variation is calculated.

The thickness of the transition zone is also determined with optical microscopy by analysing cross-sections of these slices of the tape as described above.

Preferably, the surface polymer layer comprises voids, wherein the amount of voids in the surface polymer layer is between 1 to 10 vol. %, preferably less than 5 vol. %, more preferably less than 2 vol. %, based on the total volume of the surface polymer layer.

The amount of voids is also determined with optical microscopy by analysing cross-sections of these slices of the tape as described. From the thickness of the surface polymer layer, the void volume and the broadness of the slices of the tape the volume of the surface polymer layer as well as the amount of voids, expressed in vol.%, has been calculated.

Preferably, the polymer is a thermoplastic polymer and the unidirectional fibers are carbon fibers.

The figures show

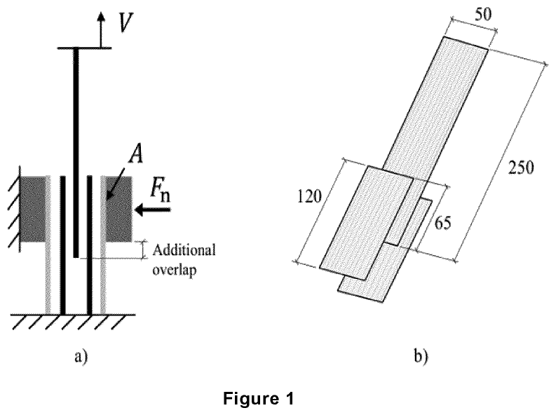

FIG. 1a Schematic drawing of friction testing,

FIG. 1b Schematic drawing of the friction testing specimen,

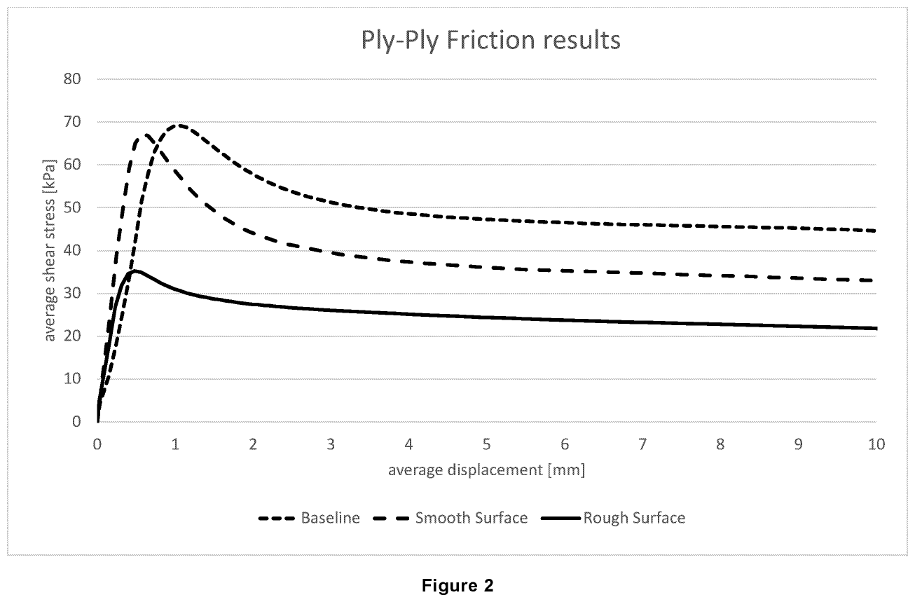

FIG. 2 Results of the shear stress measurements,

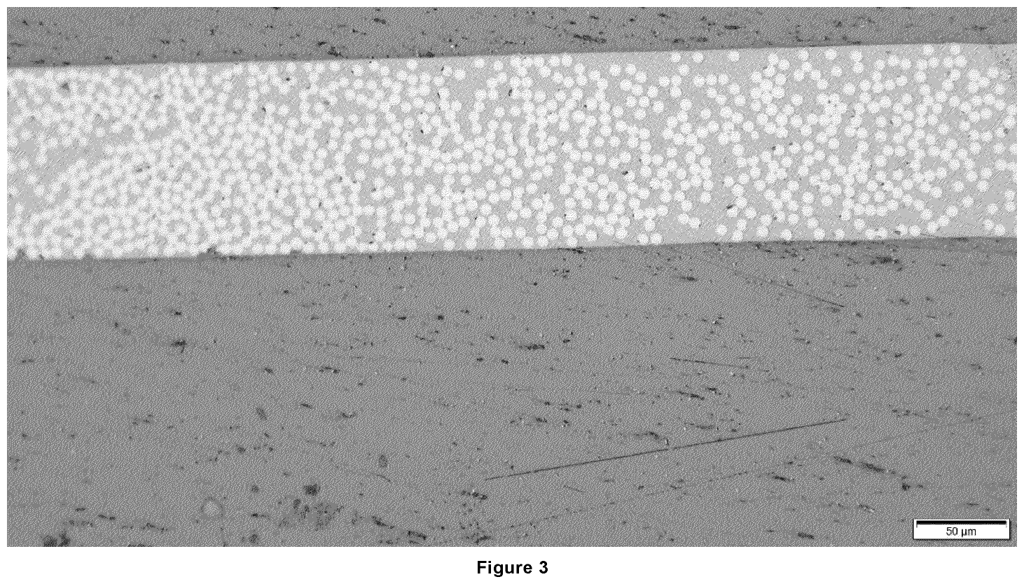

FIG. 3 Micrograph image of the comparative example, and

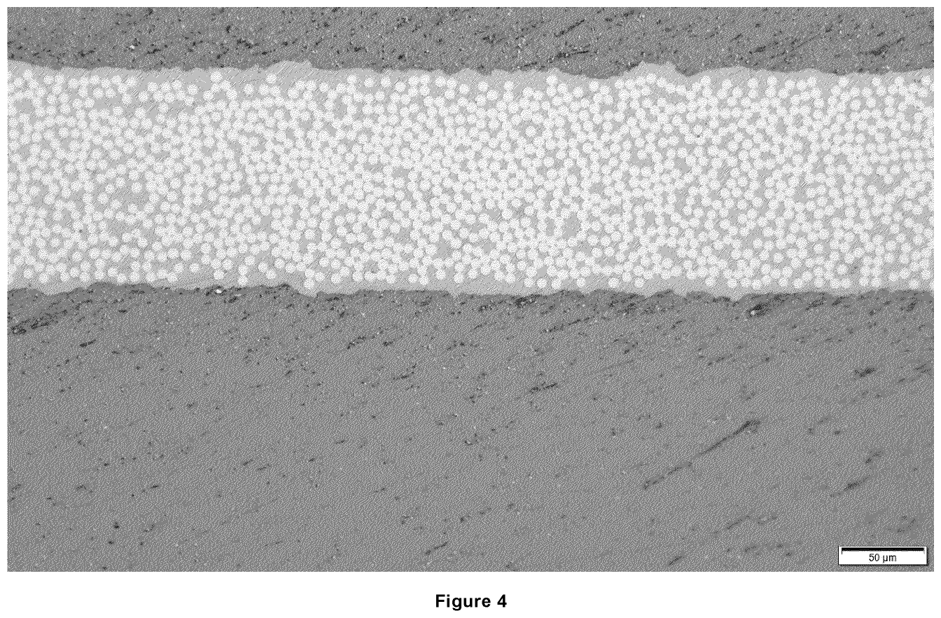

FIG. 4 Micrograph image of the inventive example.

The invention is further illustrated by way of a non-limiting example below.

### EXAMPLES

### Material and Sample Preparation

Material tested was carbon fiber reinforced (PAEK)-based polymer 145 gsm UD tape. In addition to a reference UD tape, two additional tapes were prepared. The comparative tape was made by pressing between normal smooth surfaces, whereas the inventive tape was made by pressing between roughened surfaces in accordance with the present invention.

### Ply-Ply Friction Testing Set-Up

Ply-ply friction tests were performed on a benchmarked friction tester schematically shown in FIG. 1a. A specimen consists of two outer plies and a middle ply with all fibers aligned in the longitudinal direction, as visualized in FIG. 1b. FIG. 1b schematically shows the specimen with dimensions given in millimeter. The specimen was mounted in a universal testing machine. The velocity V of the upper clamp can be controlled resulting in a relative movement between the middle ply and the outer plies. The resulting pull force, Fp, was measured using a 1 kN loadcell, which was used to calculate the shear stress:

$$τ = \frac{{F}_{p}}{2 A}$$

With A the area of the heated pressure plates (50×50 mm²). A normal force Fn can be applied on the plates, which was measured using three loadcells. The pressurized area remained constant by using an additional overlap of 15 mm as shown in FIG. 1a.

As can be seen from FIG. 2, a clear drop in shear stress is observed for both the peak value as well as the plateau for the inventive example (rough surface).

A lower shear stress results in better processing behavior.

### Micrographs

Micrographs of a cross section of both the comparative example with smooth surface (FIG. 3) as well as the inventive example with rough surface (FIG. 4) were taken with a microscope with a magnification of ×20. FIGS. 3 and 4 show each the polished surface perpendicular to the carbon fiber direction.

1. A method for producing a unidirectional tape with a surface polymer layer, the method comprising the steps of
a) providing an impregnation slurry comprising particles of a polymer, water, optionally a surfactant, optionally an organic carrying medium, optionally organic compounds and optionally surface active compounds, and providing a pressing tool having a surface profile structure, the surface profile
structure having a surface roughness Ra of 1 to 20 μm,
b) impregnating a unidirectional fiber layer comprising unidirectional fibers with the impregnation slurry to obtain an impregnated unidirectional fiber layer comprising the particles of the polymer,
c) pressing at a surface of the impregnated unidirectional fiber layer with the surface profile structure to move at least some of the particles of the polymer within the impregnated unidirectional fiber layer onto the surface to form a surface polymer layer on the unidirectional fiber layer,
d) obtaining a unidirectional tape with a surface polymer layer.

2. The method according to claim 1, wherein the polymer is a thermoplastic polymer.

3. The method according to claim 2, wherein the thermoplastic polymer comprises, or consists of, polyaryletherketone (PAEK)-based polymeric material, polyphenylene sulphide (PPS), polyetherimide (PEI), polyethersulfone (PESLI, PES) or polysulfone (PSU).

4. The method according to claim 3, wherein the polyaryletherketone (PAEK)-based polymeric material is selected from the group consisting of poly-ether-ketone (PEK), polyether-ether-ketone (PEEK), poly-ether-ether-ketone-ketone (PEEKK), poly-ether-ether-ketone-ketone (PEKK), poly-ether-ketone-ether-ketone-ketone (PEKEKK), poly-ether-ether-ketone-ether-ketone (PEEKEK), poly-ether-ether-ether-ketone (PEEEK), and poly-ether-diphenyl-ether-ketone (PEDEK), meta-polyether-ether-ketone (PEmEK), copolymers thereof and blends thereof.

5. The method according to claim 1, wherein the unidirectional fibers are carbon fibers and/or glass fibers and/or quartz.

6. The method according to claim 1, wherein the surface polymer layer has a surface roughness Ra of 1 to 20 pm.

7. The method according to claim 1, further comprising the step of
e) drying the unidirectional fiber layer, wherein step e) is performed between impregnating step b) and pressing step c).

8. The method according to claim 1, further comprising the step of
f) cooling the unidirectional fiber layer before or while performing pressing step c).

9. The method according to claim 1, wherein pressing step c) is performed while the unidirectional fiber layer is at a temperature T being in the range
(Tc−150° C.)<T<(Tc+150° C.)
wherein Tc is the crystallization temperature of the polymer.

10. The method according to claim 1, wherein the surface profile structure comprises protrusions for pressing the impregnated unidirectional fiber layer and recesses for receiving the polymer pressed out of the impregnated unidirectional fiber layer.

11. The method according to claim 1, further comprising step g) of electrostatically depositing secondary particles on the surface polymer layer.

12. Unidirectional tape with a surface polymer layer obtained by the method according to claim 1.

13. Unidirectional tape comprising a unidirectional fiber layer and a surface polymer layer, wherein the unidirectional fiber layer comprises unidirectional fibers and particles of a polymer and wherein the surface polymer layer comprises particles of the polymer, characterized by the surface polymer layer having a surface roughness Ra of 1 to 20 pm and having a thickness of less than 15 pm.

14. Unidirectional tape according to claim 13, further comprising a transition zone, wherein the transition zone is located between the unidirectional fiber layer and the surface polymer layer, wherein a thickness of the transition zone is between 2 to 15 pm, and/or wherein a thickness variation of the surface polymer layer is between 0 and 75% of an average surface polymer layer thickness, and/or wherein the surface polymer layer comprises voids, wherein the amount of voids in the surface polymer layer is between 1 to 10 vol. % based on the total volume of the surface polymer layer.

15. Unidirectional tape according to claim 13, wherein the polymer is a thermoplastic polymer and the unidirectional fibers are carbon fibers.
